(19) United States
(12) Patent Application Publication
(10) Pub. No.: US 2012/0036751 A1
(43) Pub. Date: Feb. 16, 2012

(54) FRONT AND REAR PANEL DISPLAY

(75) Inventors: Robin Wang, Foshan City (CN); Patrick Foley, Indianapolis, IN (US)

(73) Assignee: DEFLECTO LLC, Indianapolis, IN (US)

(21) Appl. No.: 13/097,553

(22) Filed: Apr. 29, 2011

Related U.S. Application Data
(63) Continuation of application No. 29/367,680, filed on Aug. 11, 2010.

(51) Int. Cl. G09F 7/04; B23P 11/00; G09F 15/00

(52) U.S. Cl. 40/600; 40/606.01; 29/428

(57) ABSTRACT

A display device including a front panel; and a rear panel detachably connected to the front panel via at least one fastening means.

### CROSS-REFERENCE TO RELATED APPLICATIONS

This application is a continuation of U.S. application Ser. No. 29/367,680, entitled “Snapable Front and Rear Panel Sign Holder,” filed on Aug. 11, 2011, all of which is incorporated herein by reference.

### FIELD OF THE INVENTION

The present inventive concept generally relates to a display for signs, posters, advertisements and other informational material. In particular, the invention relates to a display in which the front and rear panels easily attach and detach.

### BACKGROUND OF THE INVENTION

Various displays are known in the art that permit an individual or company to display and protect signs, posters, advertisements and other informational material. In typical displays the front and rear panel are not detachable or attachable to each other, rather they are one piece in which the sign is slid through an opening along the top, bottom or side edge so that the sign is positioned in-between the front and rear of the display. In addition, there are displays where an edge of the display frame can be removed to allow a sign to be inserted along the edge, positioned within the frame and then the removed edge is secured back to the frame of the display panel. With these display panels, it can be difficult to insert a sign without the sign buckling or wrinkling as it is inserted into the display.

What is needed, therefore, is a display in which the front and rear panels are easily attached and detached to each other, thereby permitting a sign, poster, advertisement or the like to easily be placed and removed within the display.

### SUMMARY OF THE INVENTION

The present invention relates to a display for signs, posters, advertisements and other informational material. Specifically, the display has front and rear panels that are easily attached and detached to each other, thereby permitting a sign or the like to be easily placed and removed within the display.

In one embodiment of the invention the display device includes a front panel and a rear panel detachably connected to the front panel via at least one fastening means.

In another embodiment of the invention the fastening means includes a male portion within the front panel and a corresponding female portion within the rear panel. The female portion can also be within the front panel and a corresponding male portion can be within the rear panel. Further, the male and female portion can be magnetic.

In another embodiment of the invention, the rear panel includes a raised border along at least a portion of the periphery of the rear panel.

In another embodiment of the invention, the display device is attached to a stand.

In another embodiment of the invention a sign, advertisement, notice or the like is removably placed in-between the front and rear panels.

Another embodiment of the invention is a method for manufacturing a display device that includes the steps of forming a front panel, forming a first portion of a fastening means within the front panel, forming a rear panel, forming a corresponding second portion of a fastening means within the rear panel and detachably connecting the front panel to the rear panel via the first and second portion of the fastening means.

In this embodiment, the first portion of the fastening means is a male portion and the second portion of the fastening means is a female portion. In yet another embodiment, the first portion of the fastening means is a female portion and the second portion of the fastening means is a male portion.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the presently preferred embodiments of the invention and, together with the description, serve to explain the advantages and principles of the invention. In the drawings:

FIG. 1 is a front view of the Front and Rear Panel according to principles of the invention;

FIG. 2 is a rear view of the Front and Rear Panel according to principles of the invention;

FIG. 3 is a side view of the Front and Rear Panel according to principles of the invention;

FIG. 4 is a side view of the Front and Rear Panel according to principles of the invention;

FIG. 5 is a view of the Front and Rear Panel according to principles of the invention;

FIG. 6 is fragmentary and exploded view of the Front and Rear panel illustrated in FIGS. 1-5 according to principles of the invention; and

FIG. 7 is a closed view of the Front and Rear Panel according to principles of the invention.

### DETAILED DESCRIPTION OF THE INVENTION

The presently preferred embodiments according to principles of the present invention(s) will be described in detail hereinafter with reference to the accompanying drawings. Although the presently preferred embodiments will be described below with various technically preferred limitations, the scope(s) of the present invention(s) as set forth in the claims is/are not limited thereto unless otherwise described below.

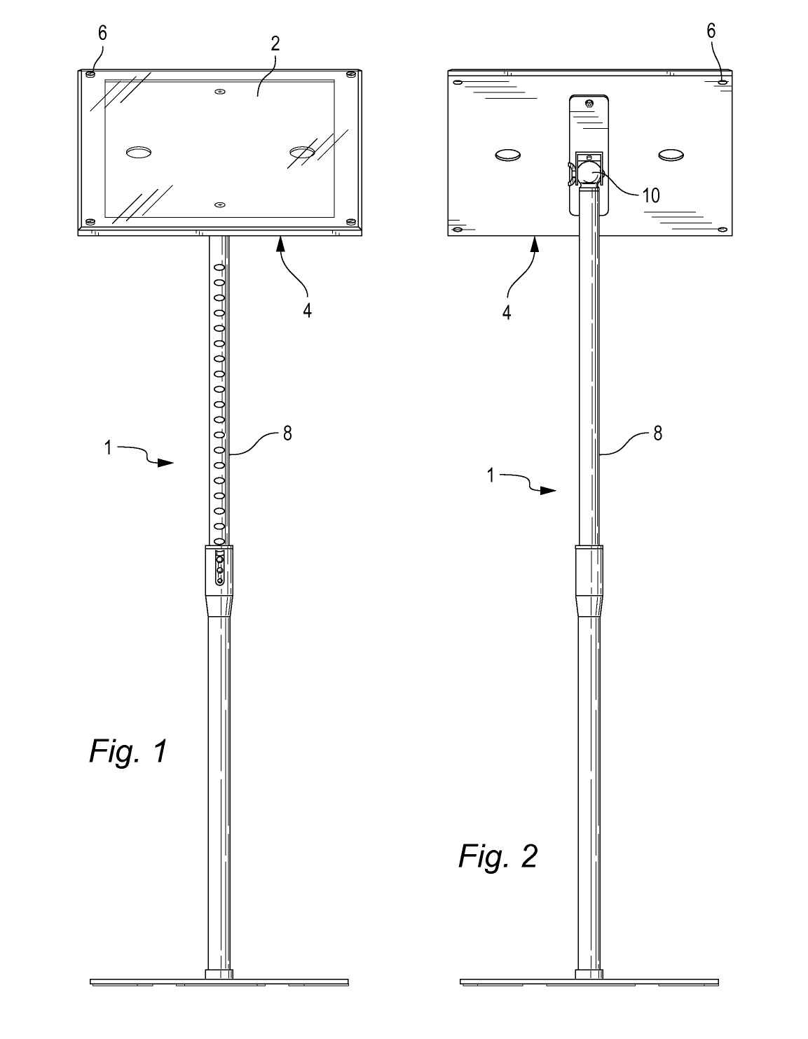

FIG. 1 shows a front view of a display device (1) that includes a front panel (2) attached to a rear panel (4) via a fastening device (6). The front and rear panels can be any shape, such as a square, rectangle, triangle or the like. Additionally, the front and rear panels can be various sizes, for example, an 11×14 inch rectangle or a 12×12 inch square. The front panel (2) material can be made of various materials known in the art including plastic such as thermoplastics or thermosetting polymers or the like. Various additives known in the art can be added to the material in order to improve the performance of the material or reduce production cost. Preferably, the front panel (2) is translucent or semi-transparent so that any material placed in-between the front panel and the rear panel can be easily viewed. The rear panel (4) can be made of similar materials and can be translucent, semi-transparent or opaque.

In this figure, the front panel (2) and rear panel (4) are attached to a display stand (8). The front and rear panels can be displayed by any known methods in the art such as an adjustable stand, a non-adjustable stand, a stand configured to be placed on a counter or table or the like. The display panel can also be configured to attach to a wall or similar surface.

FIG. 2 shows a rear view of the rear panel (4) attached to a display stand (8) via a securing means (10). The securing means (10) can be any suitable securing means known in the art. The fastening means (6) is also shown. If the rear panel is made of an opaque material, the fastening means (6) may not be seen in a rear view of the display (1).

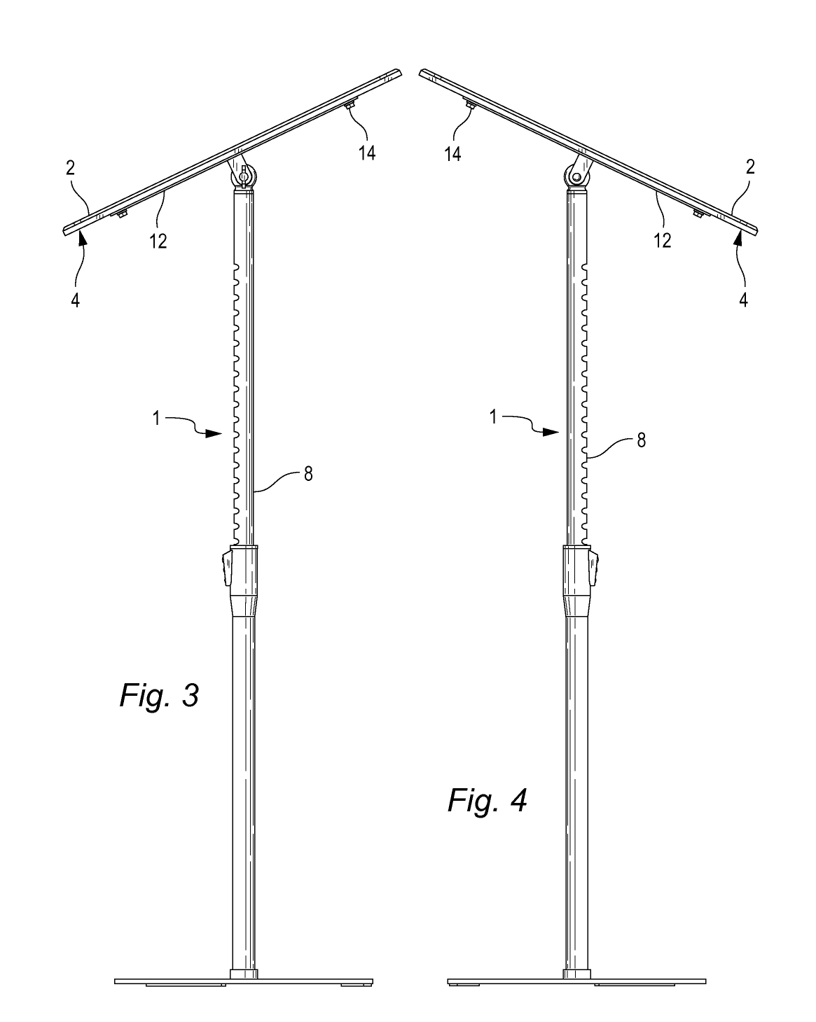

FIGS. 3 and 4 show side views of the display device (1), the front panel (2) and the rear panel (4). In this view, the rear panel (4) is attached to a base (12) via a screw (14) and the base (12) is attached or secured to the display stand (8).

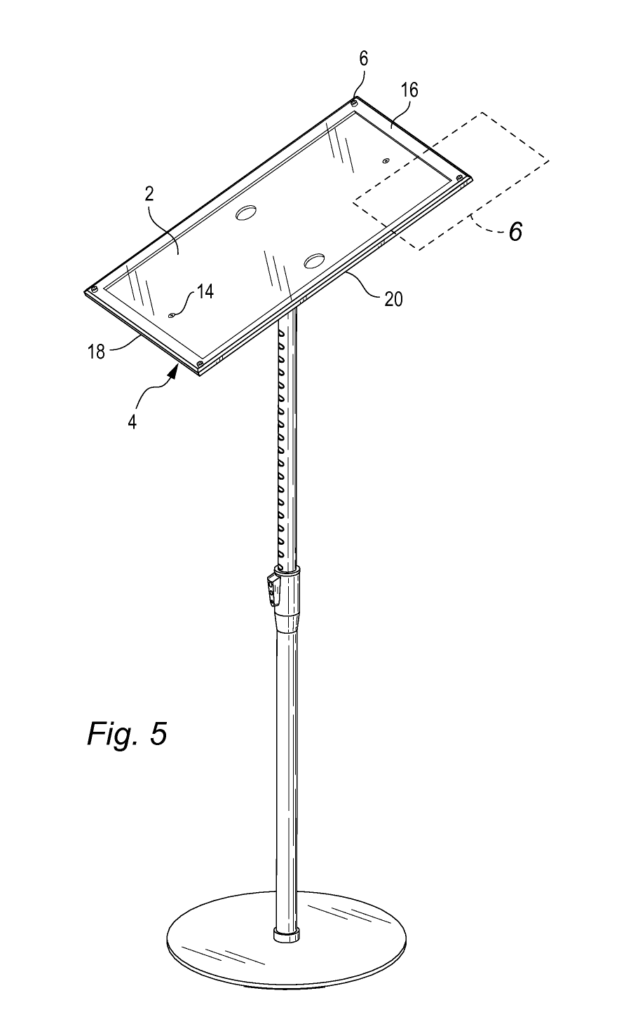

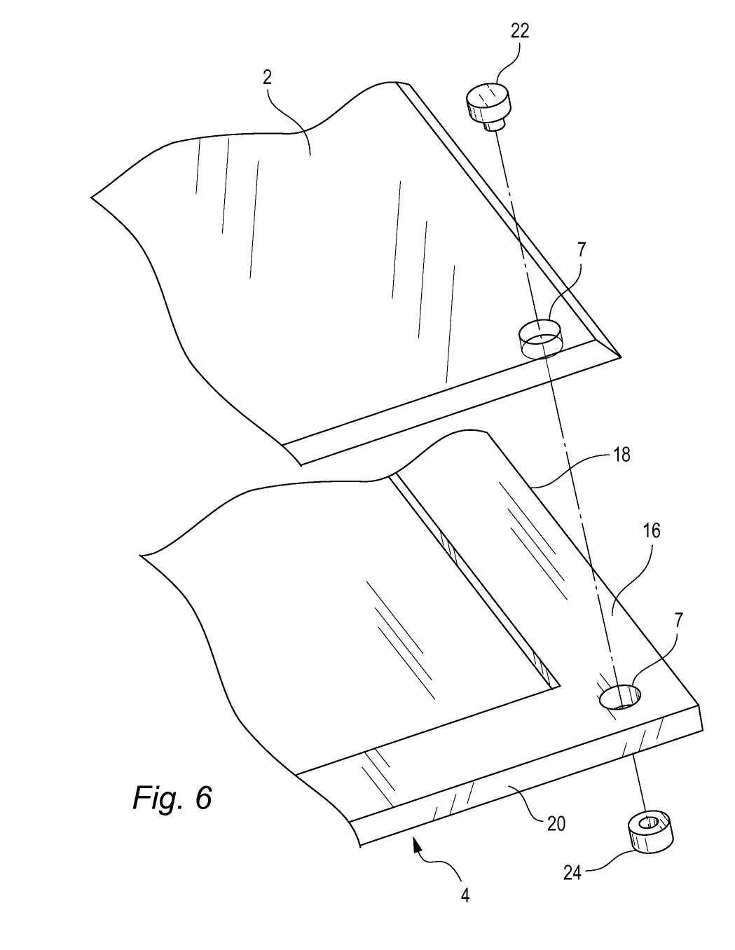

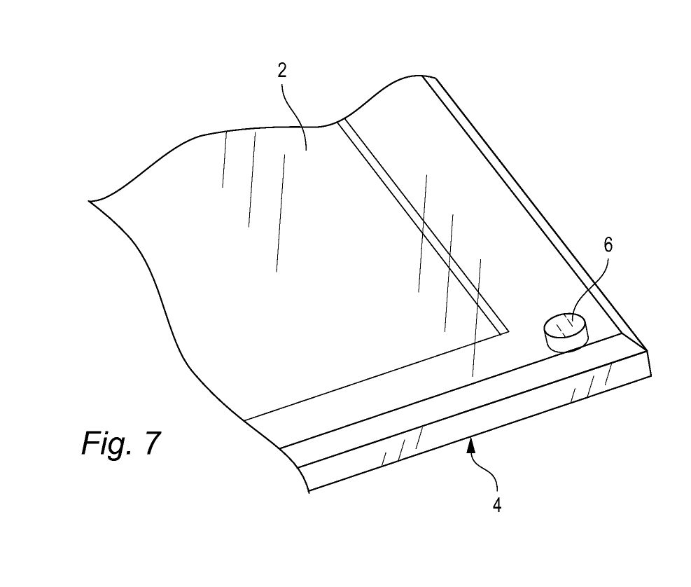

FIG. 5 is another front view of the front panel (2) and the rear panel (4). In this figure, the top portion of the fastening device (6) is shown. The screws (14) connecting the rear panel (4) to the base (12) are also shown in this figure. Additionally, a raised border (16) that runs along the periphery of the rear panel is shown. The raised border (16) can help further secure a material displayed in-between the front panel (2) and rear panel (4). The raised border also assures that the material being displayed is straight and does not become skewed. The raised border (16) is not limited to the periphery of the rear panel, it can an L-shaped raised border that is present in one or more of the corners of the rear panel. Additionally the raised border (16) can be present only along a portion of the rear panel edges, such as the top and bottom edges (18) of the rear panel or along the side edges (20) of the rear panel. Alternatively, the front panel (2) could be configured with a raised border, or both panels could be configured with raised borders.

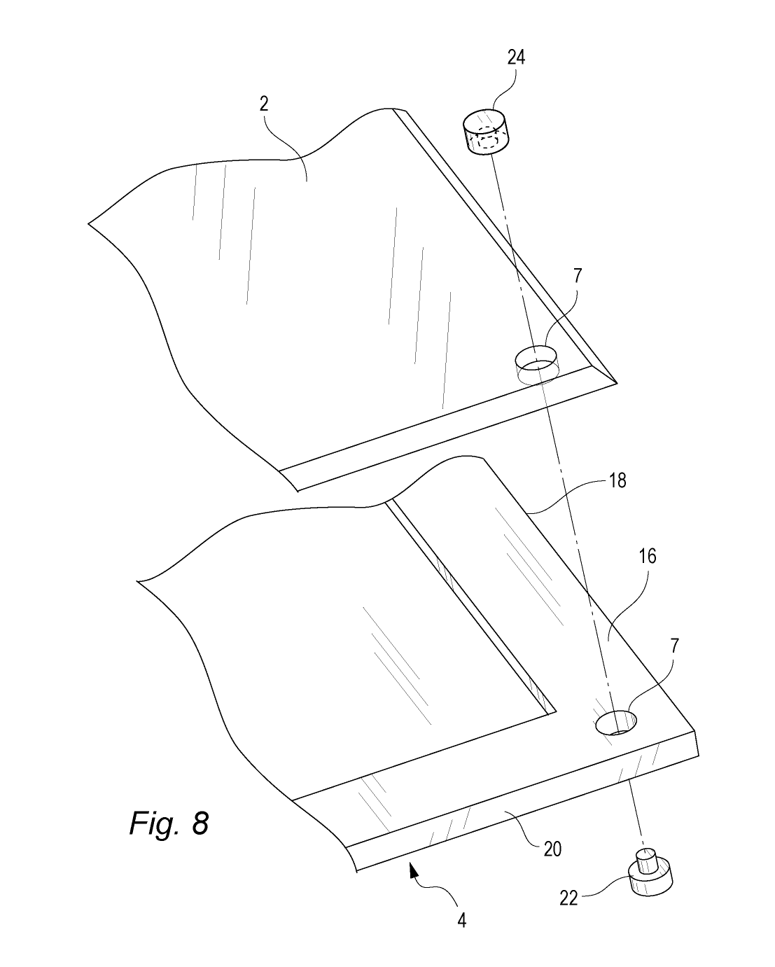

FIG. 6 shows a fragmented and exploded view of the front panel and rear panel, with the fastening device (6). The fastening device (6) is a two part device consisting of a male portion (22) and a corresponding female portion (24). The fastening device can also consist of two corresponding magnets without male and female portions. For example, the fastening device (6) can be snap, two magnetized shapes, or other configurations with corresponding male and female shapes. When the fastening device consists of male and female corresponding shapes, the connection between the front and rear panels is more secure when the display is configured vertically or the sign is impacted. The fastening device can also have a magnetized male and female shape in order to improve the hold connection between the front and rear panels. In this figure, the male portion (22) is shown as part of the front panel (2) and the female portion (24) is shown as part of the rear panel (4). The male and female portions of the fastening device (6) are not limited to front panel or the rear panel. For example, the male portion (24) could be on the rear panel and the corresponding female portion could be on the front panel. Additionally, the number of fastening devices (6) are not limited, there can be one or more fastening devices detachably connecting the front and rear panels to each other. Similarly, the location of each fastening device is not limited to the corners of the front and rear panels. For example, the fastening devices could be positioned on the top (18) or side (20) of the display panel.

The male portion (22) and female portion (24) are not limited in shape, so long as the projecting shape of the male portion (22) corresponds to opening or hole shape of the female portion (24). Additionally, the male and female portion of the fastening device can be made of various materials such as plastics or metals. The male and female portion can also be magnetized to further strengthen the connection when the front and rear panels are attached to each other.

The fastening means (6) can be embedded in the front and rear panel during a production step, or attached to the panel via any known adhesive. As shown in FIG. 6, the fastening means can be inserted into the panel via a pre-drilled hole or opening (7). FIG. 7 shows a fragmented view of the front and the rear panels attached to each other. In this figure, the male portion and the female portion of the fastening device are in contact with each other, thereby connecting the front panel to the rear panel. The panels can easily be attached and detached from each other to insert a sign, advertisement, paper or the like.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

1. A display device comprising:
a front panel; and
a rear panel detachably connected to the front panel via at least one fastening means,
wherein
the rear panel comprises a raised border along at least a portion of the periphery of the rear panel.

2. The display device according to claim 1, wherein the fastening means further comprises a male portion within the front panel and a corresponding female portion within the rear panel.

3. The display device according to claim 1, wherein the fastening means further comprises a female portion within the front panel and a corresponding male portion within the rear panel.

4. The display device according to claim 1, wherein the fastening means is a magnet.

5. (canceled)

6. The display device according to claim 1, wherein the display device is attached to a stand.

7. The display device according to claim 1, wherein a sign, advertisement or notice is removably placed in-between the front and rear panels.

8. A method for manufacturing a display device comprising the steps of:
forming a front panel;
forming a first portion of a fastening means within the front panel;
forming a rear panel;
forming a raised border along at least a portion of the periphery of the rear panel;
forming a corresponding second portion of a fastening means within the rear panel; and
detachably connecting the front panel to the rear panel via the first and second portion of the fastening means.

9. The method of manufacturing a display device according to claim 8, wherein the first portion of the fastening means is a male portion and the second portion of the fastening means is a female portion.

10. The method of manufacturing a display device according to claim 8, wherein the first portion of the fastening means is a female portion and the second portion of the fastening means is a male portion.
